(19) United States
(12) Patent Application Publication
(10) Pub. No.: US 2022/0100810 A1
(43) Pub. Date: Mar. 31, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Nobuyuki YAMAZOE, Kanagawa (JP); Toru HATORI, Kanagawa (JP); Kengo TOKUCHI, Kanagawa (JP)

(73) Assignee: FUJIFILM Business Innovation Corp., Tokyo (JP)

(21) Appl. No.: 17/319,237

(22) Filed: May 13, 2021

(30) Foreign Application Priority Data
Sep. 30, 2020 (JP) 2020-166324

(51) Int. Cl. G06F 16/9535; G06F 16/954; G06F 16/951; G06Q 10/02

(52) U.S. Cl. CPC G06F 16/9535; G06Q 10/02; G06F 16/951; G06F 16/954

(57) ABSTRACT

An information processing apparatus includes a processor configured to: acquire, in association with use of a service for providing an area on a basis of a reservation made by a user, attribute information regarding the user from a user terminal of the user, the user terminal being connected to a predetermined connection destination page; and connect the user terminal to a different connection destination page depending on a service registration status of the user regarding the service, the service registration status being extracted from the acquired attribute information.

### CROSS-REFERENCE TO RELATED APPLICATIONS

This application is based on and claims priority under 35 USC 119 from Japanese Patent Application No. 2020-166324 filed Sep. 30, 2020.

### BACKGROUND

### (i) Technical Field

The present disclosure relates to an information processing apparatus and a non-transitory computer readable medium.

### (ii) Related Art

Japanese Patent No. 5277307 discloses an information recommendation method which uses a server including a processing unit and a storage unit, reflects a response of a user who receives information related to an item in a selection criterion of an item to be recommended next time, and recommends another item. The information recommendation method includes operations in which the processing unit collects information to which the user reacts and information to which the user does not react, compares the degree of similarity between an unrecommended item and an interest item to which the user reacts with the degree of similarity between the unrecommended item and a no interest item to which the user does not react, and determines the next recommended item to the user by using the comparison result.

Japanese Patent No. 6728972 discloses a recording medium storing a program causing a computer to execute a process including obtaining the number of specific products purchased by a first consumer recommended a specific product in a recommendation period on the basis of a sales history read out from a storage, obtaining the number of specific products purchased by a second consumer not recommended the specific product in the recommendation period on the basis of the sales history read out from the storage, calculating index values each representing a consumer taste for the specific product for each of the first consumer and the second consumer, calculating a first number of purchased specific products and a second number of purchased specific products on a per index value basis, the first number representing a first consumer group, the second number representing a second consumer group, determining one of the index values that indicates that an amount of increase of the first number of purchased specific products from the second number of purchased specific products satisfies a predetermined condition, and recommending the specific product to a consumer having the determined index value.

Japanese Unexamined Patent Application Publication No. 2020-47156 discloses a product recommending apparatus including an obtaining unit, a classification unit, and a controller. The obtaining unit obtains a purchase history and a promotion history. The purchase history indicates information on a product purchased by a user. The promotion history indicates information on a product promoted to a user. The classification unit classifies, using the purchase history and the promotion history, products into a first group of items purchased but not promoted, a second group of items purchased and promoted, a third group of items not purchased and not promoted, and a fourth group of items not purchased but promoted. The controller outputs an item by using a result of the classification performed by the classification unit. The item is not purchased if the item is not promoted as an item to be recommended to a user but is purchased if the item is promoted.

### SUMMARY

There is technology for permitting access to a reserved service or the like if location information regarding a user who accesses the reserved service by using code information such as a barcode indicates that the user is near the location of the service provider.

Aspects of non-limiting embodiments of the present disclosure relate to providing an information processing apparatus and a non-transitory computer readable medium that enable a user accessing a reservation service with a terminal of the user to be guided according to the status of the user as compared to a case where guidance only for a connection destination page for the reservation service is given.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire, in association with use of a service for providing an area on a basis of a reservation made by a user, attribute information regarding the user from a user terminal of the user, the user terminal being connected to a predetermined connection destination page; and connect the user terminal to a different connection destination page depending on a service registration status of the user regarding the service, the service registration status being extracted from the acquired attribute information.

### BRIEF DESCRIPTION OF THE DRAWINGS

An exemplary embodiment of the present disclosure will be described in detail based on the following figures, wherein:

FIG. 1 is a diagram of the schematic configuration of an information processing system according to the exemplary embodiment of the present disclosure;

FIG. 2 is a block diagram of an information processing apparatus according to the exemplary embodiment of the present disclosure;

FIG. 3 is a block diagram illustrating an example functional configuration of a read only memory (ROM) or a memory of the information processing apparatus according to the exemplary embodiment of the present disclosure;

FIG. 4 is a flowchart illustrating an example of the operation of the information processing apparatus according to the exemplary embodiment of the present disclosure;

FIG. 5 is a view illustrating an example screen displayed on a user terminal connected to a connection destination page (hereinafter, simply referred to as a page on occasions) for unlocking a booth according to the exemplary embodiment of the present disclosure;

FIG. 6 is a view illustrating an example screen displayed on the user terminal connected to a page for reporting an error according to the exemplary embodiment of the present disclosure;

FIG. 7 is a view illustrating an example screen displayed on the user terminal connected to a page for announcing update information according to the exemplary embodiment of the present disclosure;

FIG. 8 is a view illustrating an example screen displayed on the user terminal connected to a page for performing procedures for full registration according to the exemplary embodiment of the present disclosure;

FIG. 9 is a view illustrating an example screen displayed on the user terminal connected to a page for making a reservation according to the exemplary embodiment of the present disclosure; and

FIG. 10 is a view illustrating an example screen displayed on the user terminal yet to be connected to the page for making a reservation according to the exemplary embodiment of the present disclosure.

### DETAILED DESCRIPTION

Hereinafter, an example of an exemplary embodiment of the present disclosure will be described with reference to the drawings. The same or equivalent components and parts are denoted by the same reference numerals throughout the drawings. The ratios of the dimensions in the drawings are exaggerated for convenience of explanation and are different actual ratios on occasions.

A service of providing an area to a user who has made a reservation on the basis of the reservation is described in this exemplary embodiment by taking as an example a service of providing booths 20 serving as shared spaces. Note that the service of providing an area to the user who has made a reservation on the basis of the reservation is not limited to the service of providing the booths 20 and includes a service of providing any area such as a seat in the restaurant or a seat in an eat-in space.

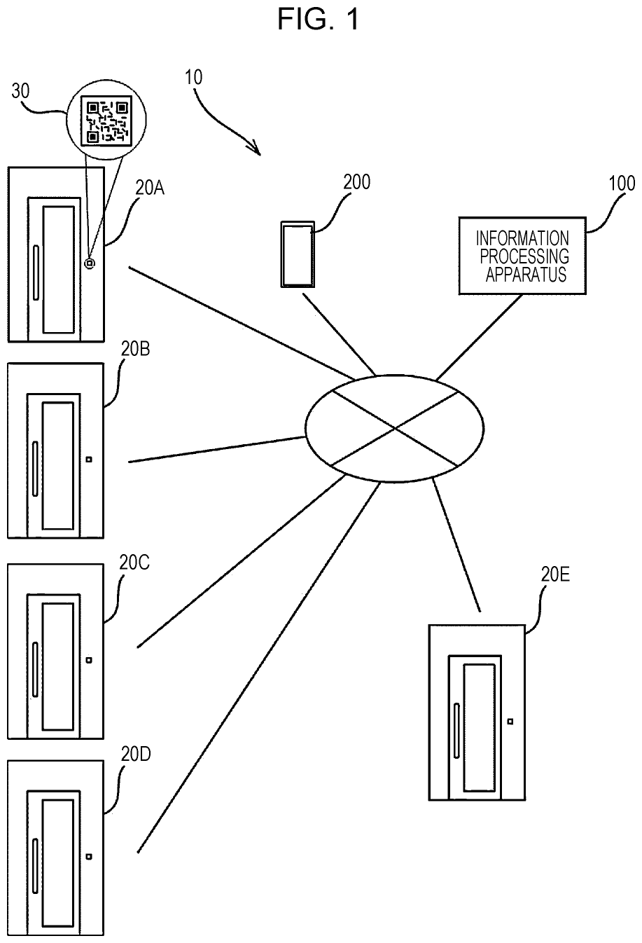

FIG. 1 is a diagram of the schematic configuration of an information processing system 10 according to this exemplary embodiment. The information processing system 10 according to this exemplary embodiment includes an information processing apparatus 100 and booths 20A to 20E serving as shared spaces. The information processing apparatus 100 controls service registration statuses and booth reservation. When being not discriminated from each other in the following description, the booths 20A to 20E are simply referred to as the booths 20. The booths 20 include the booths 20 arranged in series in one area and provided in a different area. This exemplary embodiment illustrates a state where the four booths 20A to 20D are arranged in series in the same area and the booth 20E is provided in an area different from the area for the booths 20A to 20D. FIG. 1 also illustrates a user terminal 200 for reserving a booth, such as a smartphone.

Each booth 20 is a shared space to be used by a user who has a full membership as the service registration status and has completed all of predetermined procedures. The user having made a reservation in advance may use a booth 20. The booth shape is not limited to a box shape like a phone booth as illustrated in FIG. 1, and each booth 20 may be a partitioned booth with an open ceiling. In addition, the booth 20 does not exclude an open seating booth without partitions. In this exemplary embodiment, the door of the booth 20 is locked, and the user having the reservation connects to a page for unlocking the booth 20 (described later).

As illustrated in FIG. 1, each booth 20 has a code image 30 expressing a two-dimensional code such as QR code (registered trademark) on the wall. The code image 30 expresses a uniform resource locator (URL). In the URL in this exemplary embodiment, a query string identifying the location and the name and the like of the booth 20 is added to the URL for the service. The user uses the user terminal 200 such as the smartphone to read the code image 30 and thereby may access the read URL. The code image 30 does not have to be read every time. A URL obtained from the code image 30 read in the past may be stored, and a URL may be received, via e-mail or the like, from a third party having read the code image 30. Accessing the URL may be performed by reading the code image 30, but the way of accessing does not exclude accessing the URL for the service with the smartphone or a personal computer.

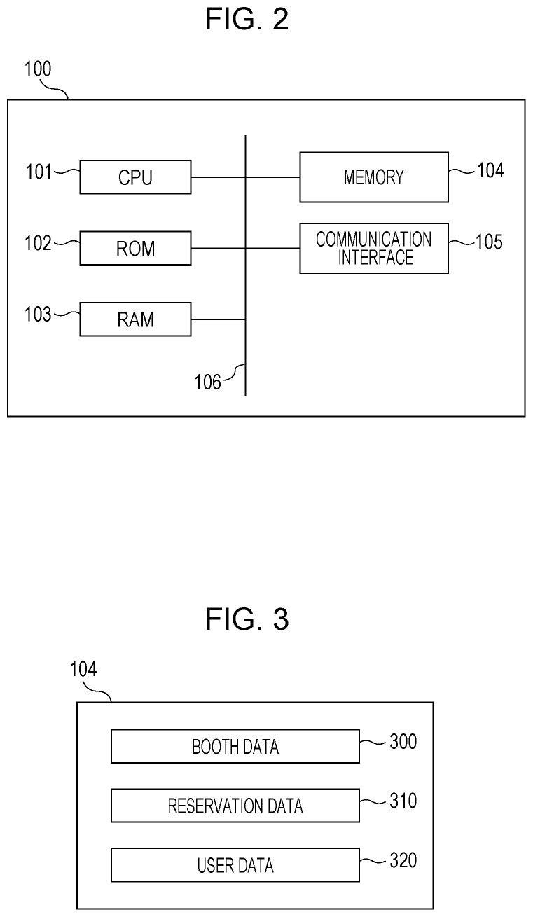

FIG. 2 is a block diagram illustrating the hardware configuration of the information processing apparatus 100. The information processing apparatus 100 is configured, for example, by using a computer.

As illustrated in FIG. 1, the information processing apparatus 100 includes a central processing unit (CPU) 101 that is an example of a processor, a ROM 102, a random access memory (RAM) 103, a memory 104, and a communication interface 105. The components are connected to be able communicate with each other via a bus 106.

The CPU 101 runs various programs and control the components. Specifically, the CPU 101 reads out a program from the ROM 102 or the memory 104 and runs the program with the RAM 103 used as a work area. The CPU 101 runs the program stored in the ROM 102 or the memory 104 to control the components and perform various arithmetic operations. In this exemplary embodiment, the programs are stored in the ROM 102 or the memory 104.

The ROM 102 stores various programs and various pieces of data. The RAM 103 temporarily stores a program or data to serve as the work area. The memory 104 is configured by using a hard disk drive (HDD) or a solid state drive (SSD) and stores various programs including the operating system and various pieces of data.

As illustrated in FIG. 3, the memory 104 of the information processing apparatus 100 has respective memory areas for booth data 300, reservation data 310, and user data 320 and stores the various pieces of data.

The booth data 300 is data storing booth information. The booth information includes a location, room temperature, an air conditioner operating state, an availability, entry and exit information, and other pieces of information regarding each booth.

The reservation data 310 is data storing reservation information. The reservation information includes information indicating whether a reservation has been made, a use history per user, and other pieces of information.

The user data 320 is data storing user information. The user information includes a user attribute such as full registration or temporary registration as the registration status of the user, a name, an address, a membership type indicating individual membership or corporate membership, and other pieces of information.

The information processing apparatus 100 implements various functions by using the hardware resources described above. The functional configuration of the information processing apparatus 100 will be described.

In the information processing apparatus 100 configured as described above, the CPU 101 runs a program stored in the ROM 102 or the memory 104 after reading out the program and thereby executes various processes.

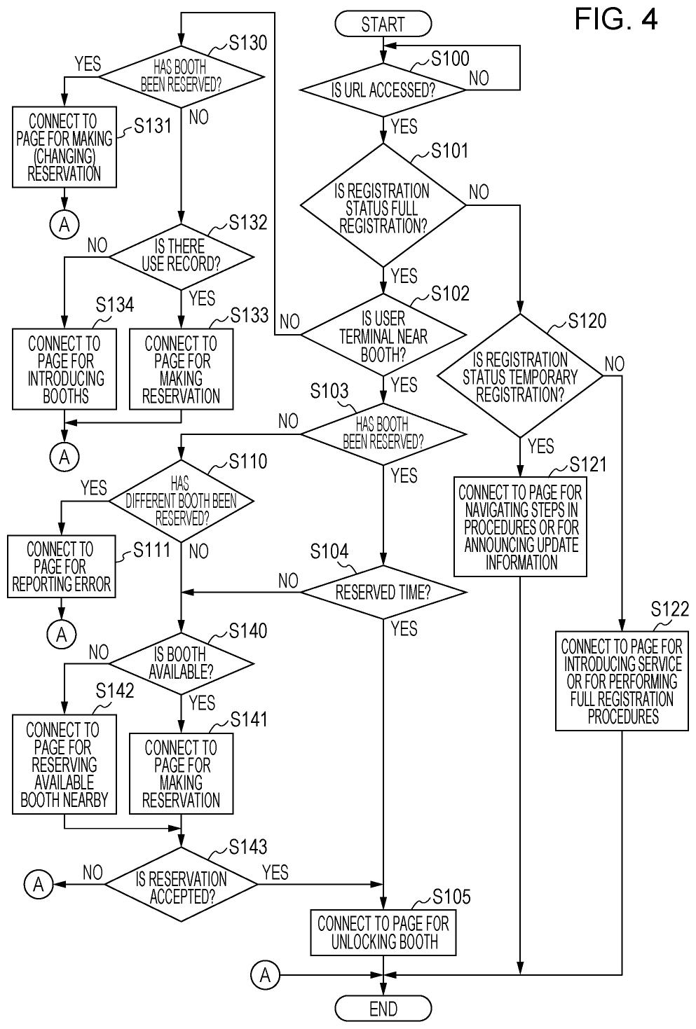

Actions of the information processing apparatus 100 will be described. The CPU 101 runs an information processing program, and thereby the process illustrated in FIG. 4 is executed. The process is started when the user accesses a URL read from the code image 30 on the wall of the booth 20 with the user terminal 200 such as the smartphone.

FIG. 4 is a flowchart illustrating an example of the operation of the information processing apparatus 100.

The operation does not necessarily have to be performed in the order in FIG. 4 and may be performed in any order if the purpose is achieved.

In step S100 illustrated in FIG. 4, the CPU 101 determines whether the URL read from the code image 30 on the wall of a booth 20 is accessed. If the CPU 101 determines that the URL is accessed, the process proceeds to subsequent step S101. In contrast, if the CPU 101 does not determine that the URL is accessed, the process performs step S100 again.

In step S101, the CPU 101 determines whether the service registration status extracted from the user attribute information acquired from the user terminal 200 is full registration in which all of the predetermined procedures are complete. For the determination, existing technology is used. For example, the CPU 101 acquires a cookie or session information of the browser stored as the service registration status in the user terminal 200 and thereby determines the service registration status. If the CPU 101 determines that the status is the full registration, the process proceeds to subsequent step S102. In contrast, if the CPU 101 does not determine that the status is the full registration, the process proceeds to step S120 (described later).

In step S102, the CPU 101 determines whether the user is near the location of the booth 20 identified from the URL accessed by the user terminal 200 in step S100, for example, within several meters. For the determination, existing technology is used. For example, the location of the user terminal 200 is acquired from the global positioning system (GPS) of the user terminal 200, a mobile phone base station, a public wireless local area network (LAN), or the like. If the CPU 101 determines that the user is near the booth 20, the process proceeds to subsequent step S103. In contrast, if the CPU 101 determines that the user is not near the booth 20, the process proceeds to step S130 (described later).

In step S103, the CPU 101 determines whether the booth 20 has been reserved. For the determination, existing technology is used. For example, the CPU 101 acquires a cookie or session information of the browser stored as a reservation state in the user terminal 200 and thereby determines whether the booth 20 has been reserved. If the CPU 101 determines that the booth 20 has been reserved, the process proceeds to subsequent step S104. In contrast, if the CPU 101 determines that the booth 20 has not been reserved, the process proceeds to step S110 (described later).

The criterion for the determination of whether the booth 20 has been reserved is not limited to the information stored in the user terminal 200. The determination may be performed on the basis of information stored in the reservation data 310 of the information processing apparatus 100.

In step S104, the CPU 101 determines whether the current time is time for which the booth 20 is reserved (reserved time). If the CPU 101 determines that the current time is the reserved time, the process proceeds to subsequent step S105. If the CPU 101 determines that the current time is not the reserved time, the process proceeds to step S140 (described later).

The criterion for the determination of whether the current time is the reserved time includes not only just the reserved time but also time within a predetermined time period before and after the reserved time such as time within ten minutes.

In step S105, the CPU 101 connects the user terminal 200 to a page for unlocking the booth 20. For the connection, existing technology is used. For example, Javascript (registered trademark) is run on the browser of the user terminal 200, and thereby the connection is redirected from the URL accessed in step S100 to the page for unlocking the booth 20. Hereinafter, to connect to a page, Javascript (registered trademark) is likewise run on the browser of the user terminal 200. The connection method is not limited to the running of Javascript (registered trademark) on the browser of the user terminal 200, and a different method may be used to connect to a page.

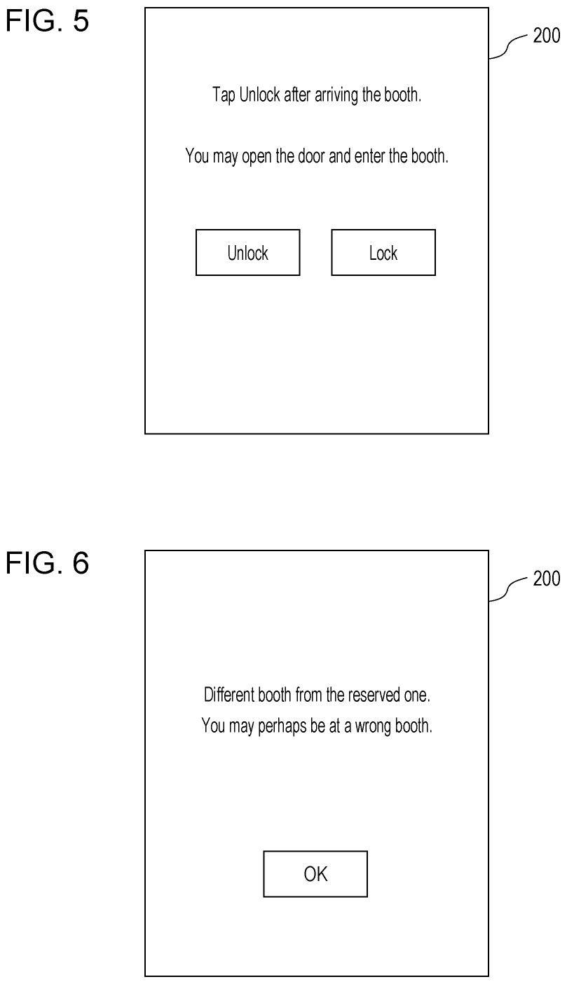

FIG. 5 illustrates an example screen displayed on the user terminal 200 for the unlocking. In response to the user selecting (taping) Unlock displayed, a signal is transmitted to the information processing apparatus 100. The information processing apparatus 100 receiving the signal transmits an unlocking signal via a network to a locking unit of the booth 20 (a controller that manages the unlocking of the booth 20) to unlock the booth 20. The process is then terminated.

The specification of the unlocking process is not limited to the specification described above, and the booth 20 may be unlocked in the following manner. Specifically, the user terminal 200 is connected to the locking unit of the booth 20 (not illustrated) through a wireless LAN or Bluetooth (registered trademark), and an unlocking signal is transmitted from the user terminal 200 to the locking unit of the booth 20 directly. The unlocking of the booth 20 is thereby performed not via the information processing apparatus 100.

In step S110, the CPU 101 determines whether a different booth 20 has been reserved. If the CPU 101 determines that the different booth 20 has been reserved, the process proceeds to subsequent step S111. If the CPU 101 determines that the different booth 20 has not been reserved, the process proceeds to step S140 (described later).

In step S111, the CPU 101 performs connection to a page for causing the user terminal 200 to report that the visited booth is different from the reserved booth.

FIG. 6 illustrates an example screen displayed on the user terminal 200 for the report to that effect. In this example, the message “Different booth from the reserved one. You may perhaps be at a wrong booth.” is displayed. In response to the user selecting (tapping) OK displayed, the process is terminated.

Note that even in this case, the process may proceed to step S141 or 5142 (described later) without terminating the process. The user terminal 200 may then be connected to a page for cancelling a reservation already made and then for newly reserving a booth 20.

In step S120, the CPU 101 determines whether the service registration status extracted from the user attribute information acquired from the user terminal 200 is the temporary registration in which registration application is partially complete before the full registration. The term “temporary registration” denotes, for example, a state where only e-mail address registration is complete. If the CPU 101 determines that the service registration status is the temporary registration, the process proceeds to subsequent step S121. In contrast, if the CPU 101 does not determine that the service registration status is the temporary registration, the process proceeds to step S122 (described later).

In step S121, the CPU 101 connects the user terminal 200 to a page for navigating steps in the predetermined procedures for the full registration or a page for announcing service update information. This helps moving from the temporary registration to the full registration and enables the user to be motivated to proceed to the full registration because they know enhanced convenience being notified of the update information after the temporary registration. The process is then terminated.

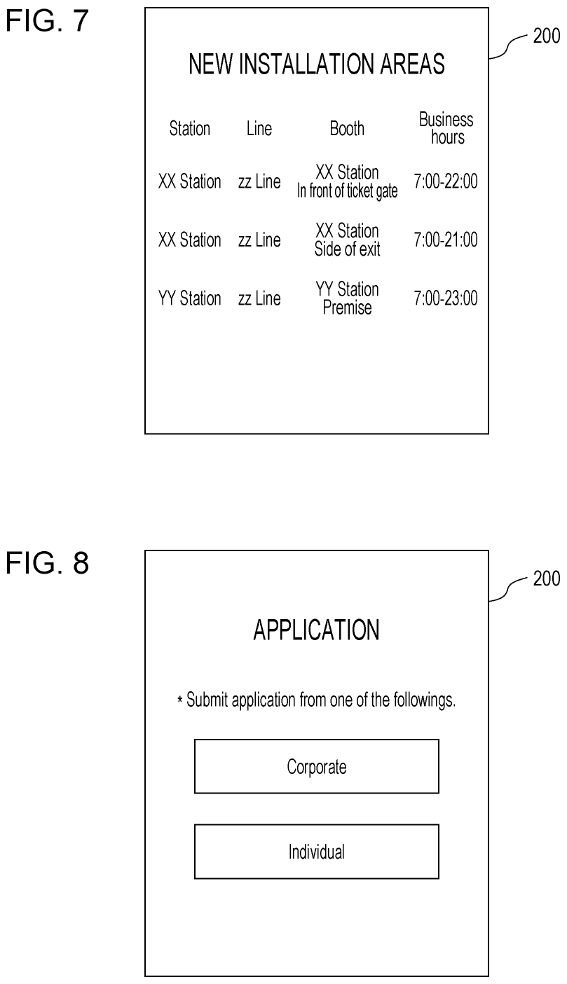

FIG. 7 illustrates an example screen displayed on the user terminal 200 connected to the page for announcing service update information. In this example, newly provided booth areas are announced. This lets the user know that the booths are newly provided in the user's sphere of activities and motivates the user to submit the full registration. Although an example screen displaying the page for navigating steps in the predetermined procedures for the full registration is not illustrated, the screen includes, for example, a screen displaying an image or a movie navigating the steps in the procedures to help a user who has not submitted the full registration because they do not know the procedures. If the full registration is submitted, data regarding the user is stored in the user data 320 of the information processing apparatus 100.

The example screen displaying the page for announcing service update information is not limited to the screen illustrated in FIG. 7, and the screen may display different information such as fee revision or service agreement revision.

In addition, even in the case where the screen in FIG. 7 is displayed, the process may proceed to step S141 or 5142 (described later) without terminating the process if the full registration is submitted. The user terminal 200 may be connected to the page for reserving a booth 20.

In step S122, the CPU 101 determines that the service registration status is absence of registration in which the service registration status is neither the full registration nor the temporary registration, and the user terminal 200 is connected to a page for introducing the service or a page for performing the procedures for the full registration.

FIG. 8 illustrates an example screen displayed on the user terminal 200 connected to the page for performing the procedures for the full registration. In this example, Corporate is selected (tapped) if the user is a corporate user, and Individual is selected (tapped) if the user is an individual user. The page on which the procedures for the full registration may be performed is displayed to thereby enable the registration to be submitted. After the full registration is submitted, data regarding the user is stored in the user data 320 of the information processing apparatus 100. The process is then terminated.

In addition, even in the case where the screen in FIG. 8 is displayed, the process may proceed to step S141 or 5142 (described later) without terminating the process if the full registration is submitted. The user terminal 200 may be connected to the page for reserving a booth 20.

In step S130, the CPU 101 determines whether the booth 20 identified from the URL accessed by the user terminal 200 in step S100 has been reserved. If the CPU 101 determines that the booth 20 has been reserved, the process proceeds to subsequent step S131. In contrast, if the CPU 101 determines that the booth 20 has not been reserved, the process proceeds to step S132 (described later).

In step S131, the CPU 101 connects the user terminal 200 to the page for reserving a booth 20. In this case, it is assumed that the user wishes to change the reservation, and a reservation may be made (changed).

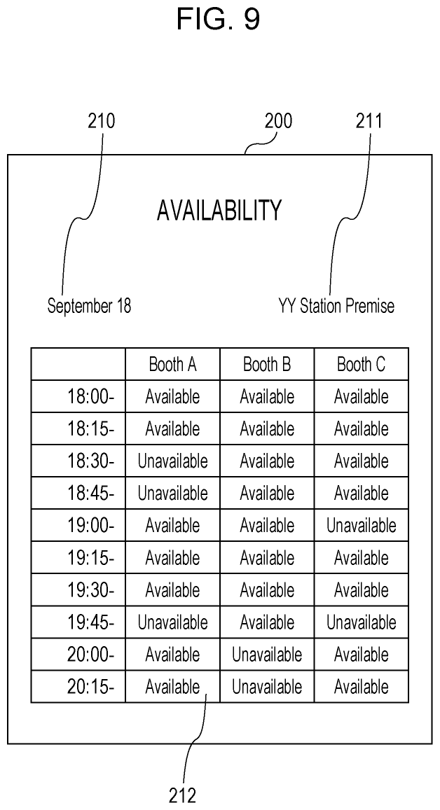

FIG. 9 illustrates an example screen displayed on the user terminal 200 connected to the page for making a reservation. In this example, the screen is configured such that selecting (tapping) a date field 210 enables a date to be reserved, selecting (tapping) a booth area field 211 enables a booth area to be changed, and selecting (tapping) one of availability fields 212 (Available denotes vacancy, and Unavailable denotes that another user has reserved the corresponding booth) enables the corresponding booth to be reserved. The process is then terminated.

In step S132, the CPU 101 determines whether there is a use record regarding the booth 20 (record of use in the past) identified from the URL accessed by the user terminal 200 in step S100. For the determination, existing technology is used. For example, the CPU 101 acquires a cookie or session information of the browser stored as a use record regarding the user terminal 200 and thereby determines whether there is a use record. If the CPU 101 determines that there is a use record, the process proceeds to subsequent step S133. In contrast, if the CPU 101 determines that there is not a use record, the process proceeds to step S134 (described later).

The criterion for the determination of whether there is a use record is not limited to the information stored in the user terminal 200. The determination may be performed on the basis of information stored in the reservation data 310 of the information processing apparatus 100.

In step S133, the CPU 101 connects the user terminal 200 to the page for making a reservation. Also in this case, like step S131 described above, the example screen in FIG. 9 is displayed on the user terminal 200. The process is then terminated.

In step S134, the CPU 101 connects the user terminal 200 to a page for introducing the booths 20. In this case, it is assumed that the service is introduced by a different user, and the booths 20 are introduced to lead the user to registration. Although an example screen displayed on the user terminal 200 connected to the page for introducing the booths 20 is not illustrated, for example, business hours for the booths 20, how to access the booths 20, or a facility list is displayed. The process is then terminated.

In step S140, the CPU 101 determines whether the booth 20 identified from the URL accessed by the user terminal 200 in step S100 is available. The determination is performed in such a manner that the CPU 101 refers to the reservation data 310. If the CPU 101 determines that the booth 20 is available, the process proceeds to subsequent step S141. In contrast, if the CPU 101 determines that the booth 20 is unavailable, the process proceeds to step S142 (described later).

In step S141, the CPU 101 connects the user terminal 200 to the page for making a reservation for a booth 20. Also in this case, like step S131 described above, the example screen in FIG. 9 is displayed on the user terminal 200. The process then proceeds to subsequent step S143.

In step S142, the CPU 101 connects the user terminal 200 to a page for reserving a booth 20 near the booth 20 identified from the URL accessed by the user terminal 200 in step S100.

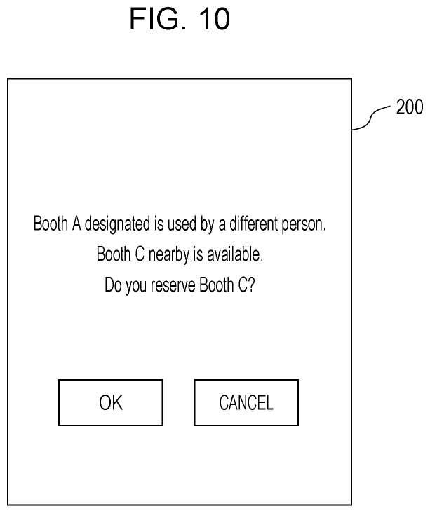

FIG. 10 illustrates an example screen displayed on the user terminal 200 yet to be connected to the page for making a reservation. In this example, the message “Booth A is used by a different person. Booth C nearby is available. Do you reserve Booth C?” is displayed. In response to the user selecting (tapping) OK, the example screen in FIG. 9 is displayed on the user terminal 200 like step S131 described above. The process then proceeds to subsequent step S143. In response to the user selecting (tapping) CANCEL, the process proceeds to step S143 without displaying the screen in FIG. 9.

The booth 20 nearby includes a booth satisfying a predetermined condition, such as a booth 20 neighboring the booth 20 identified from the URL among the booths 20 arranged in series in the same area or a booth 20 provided at the next station.

In step S143, the CPU 101 determines whether the reservation is accepted. If the CPU 101 determines that the reservation is accepted, the process proceeds to subsequent step S105. If the CPU 101 does not determine that the reservation is accepted, the process is terminated.

If a logout operation has been performed, the user terminal 200 is first connected to a page for receiving an login operation and then is connected to a corresponding page in accordance with a corresponding one of the conditions described above.

### Others

If a system operating in cooperation with the information processing system 10 is provided, control may be performed according to the cooperative system.

For example, the information processing system 10 may be configured to allow a purpose input at the time of reserving a booth 20 and to control the booth 20 in accordance with the purpose. Specifically, if the booth 20 is to be used for an English conversation lesson, a signal for unlocking a shelf in the booth 20 having equipment such as a microphone may be transmitted to the locking unit of the booth 20. If the booth 20 is equipped with a computer, software to be run in using the booth 20 may be started before the use. If the booth 20 is to be used for a meeting, sound in a phase opposite to ambient noise may be output from the speaker of the booth 20 to cancel the noise.

The information processing system 10 may be configured to allow a user's wish, such as setting the air conditioner at a low temperature, to be input at the time of reserving the booth 20 and to enable a signal for setting the air conditioner at a temperature meeting the user's wish to be transmitted to the locking unit of the booth 20.

The present disclosure is not limited to the exemplary embodiment described above, and various modifications and applications may be made without departing from the spirit of the disclosure.

For the exemplary embodiment above, the aspect in which the program is stored (installed) in the ROM 102 or the memory 104 in advance has been described; however, the exemplary embodiment is not limited to the aspect. The program may be provided in such a manner as to be stored in a recording medium such as a compact disk read only memory (CD-ROM), a digital versatile disk read only memory (DVD-ROM), or a universal serial bus (USB) memory. The program may be downloaded from an external apparatus via the network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
acquire, in association with use of a service for providing an area on a basis of a reservation made by a user, attribute information regarding the user from a user terminal of the user, the user terminal being connected to a predetermined connection destination page; and
connect the user terminal to a different connection destination page depending on a service registration status of the user regarding the service, the service registration status being extracted from the acquired attribute information.

2. The information processing apparatus according to claim 1,
wherein the service registration status includes full registration in which all of predetermined procedures are complete, temporary registration in which registration application is partially complete before the full registration, and absence of registration in which no registration has been performed, and
wherein the processor is configured to vary a connection destination page depending on whether the service registration status is the full registration, the temporary registration, or the absence of registration.

3. The information processing apparatus according to claim 2,
wherein the processor is configured to, if the service registration status is the absence of registration, connect the user terminal to a different connection destination page for introducing the service or a different connection destination page for performing the predetermined procedures for the full registration.

4. The information processing apparatus according to claim 2,
wherein the processor is configured to:
if the service registration status is the temporary registration, connect the user terminal to a different connection destination page for navigating steps in the predetermined procedures for the full registration or a different connection destination page for announcing update information regarding the service.

5. The information processing apparatus according to claim 3,
wherein the processor is configured to:
if the service registration status is the temporary registration, connect the user terminal to a different connection destination page for navigating steps in the predetermined procedures for the full registration or a different connection destination page for announcing update information regarding the service.

6. The information processing apparatus according to claim 2,
wherein the attribute information includes location information regarding the user terminal,
wherein the predetermined connection destination page is associated with a predetermined area, and
wherein the processor is configured to:
set, as one of conditions for connecting the user terminal to a different connection destination page, a case where a distance between a location of the user terminal and the predetermined area is within a predetermined distance.

7. The information processing apparatus according to claim 3,
wherein the attribute information includes location information regarding the user terminal,
wherein the predetermined connection destination page is associated with a predetermined area, and
wherein the processor is configured to:
set, as one of conditions for connecting the user terminal to a different connection destination page, a case where a distance between a location of the user terminal and the predetermined area is within a predetermined distance.

8. The information processing apparatus according to claim 4,
wherein the attribute information includes location information regarding the user terminal,
wherein the predetermined connection destination page is associated with a predetermined area, and
wherein the processor is configured to:
set, as one of conditions for connecting the user terminal to a different connection destination page, a case where a distance between a location of the user terminal and the predetermined area is within a predetermined distance.

9. The information processing apparatus according to claim 5,
wherein the attribute information includes location information regarding the user terminal,
wherein the predetermined connection destination page is associated with a predetermined area, and
wherein the processor is configured to:
set, as one of conditions for connecting the user terminal to a different connection destination page, a case where a distance between a location of the user terminal and the predetermined area is within a predetermined distance.

10. The information processing apparatus according to claim 6,
wherein the processor is configured to:
if the service registration status is the full registration,
if the distance between the location of the user terminal and the predetermined area is within the predetermined distance, and
if the predetermined area is not being used and has not been reserved for a period including current time,
connect the user terminal to a different connection destination page for reserving the predetermined area.

11. The information processing apparatus according to claim 7,
wherein the processor is configured to:
if the service registration status is the full registration,
if the distance between the location of the user terminal and the predetermined area is within the predetermined distance, and
if the predetermined area is not being used and has not been reserved for a period including current time,
connect the user terminal to a different connection destination page for reserving the predetermined area.

12. The information processing apparatus according to claim 8,
wherein the processor is configured to:
if the service registration status is the full registration,
if the distance between the location of the user terminal and the predetermined area is within the predetermined distance, and
if the predetermined area is not being used and has not been reserved for a period including current time,
connect the user terminal to a different connection destination page for reserving the predetermined area.

13. The information processing apparatus according to claim 6,
wherein the processor is configured to:
if the service registration status is the full registration,
if the distance between the location of the user terminal and the predetermined area is within the predetermined distance, and
if the predetermined area is being used,
connect the user terminal to a different connection destination page for reserving an area that is different from the predetermined area and that satisfies a predetermined condition.

14. The information processing apparatus according to claim 6,
wherein the processor is configured to:
if the service registration status is the full registration,
if the distance between the location of the user terminal and the predetermined area is not within the predetermined distance,
if the predetermined area has not been reserved for a period including current time, and
if there is a record of use of the predetermined area by the user in past,
connect the user terminal to the different connection destination page for reserving the predetermined area.

15. The information processing apparatus according to claim 6,
wherein the processor is configured to:
if the service registration status is the full registration,
if the distance between the location of the user terminal and the predetermined area is not within the predetermined distance, and
if there is not a record of use of the predetermined area by the user in past,
connect the user terminal to a different connection destination page for introducing an area.

16. The information processing apparatus according to claim 6,
wherein the processor is configured to:
if the service registration status is the full registration,
if the distance between the location of the user terminal and the predetermined area is within the predetermined distance, and
if current time is time for which the user has reserved the predetermined area,
connect the user terminal to a different connection destination page for unlocking a facility in the predetermined area or transmit a signal for unlocking the facility in the predetermined area to a locking unit installed in the predetermined area.

17. The information processing apparatus according to claim 6,
wherein the processor is configured to:
if the service registration status is the full registration,
if the distance between the location of the user terminal and the predetermined area is within the predetermined distance,
if current time is outside time for which the user has reserved the predetermined area, and if a different user has not reserved or is not using the predetermined area,
connect the user terminal to a different connection destination page for unlocking a facility in the predetermined area or transmit a signal for unlocking the facility in the predetermined area to a locking unit installed in the predetermined area.

18. The information processing apparatus according to claim 1,
wherein the predetermined connection destination page is expressed by a code image readable by the user terminal, and
wherein the code image is provided in a predetermined area associated with the predetermined connection destination page.

19. The information processing apparatus according to claim 18,
wherein the processor is configured to:
if the predetermined area provided with the code image read by the user terminal is different from the area reserved by the user of the user terminal,
connect the user terminal to a different connection destination page for reporting that a visited area is different from a reserved area.

20. A non-transitory computer readable medium storing a program causing a computer to execute a process for information processing, the process comprising:
acquiring, in association with use of a service for providing an area on a basis of a reservation made by a user, attribute information regarding the user from a user terminal of the user, the user terminal being connected to a predetermined connection destination page; and
connecting the user terminal to a different connection destination page depending on a service registration status of the user regarding the service, the service registration status being extracted from the acquired attribute information.
